(19) United States
(12) Patent Application Publication
(10) Pub. No.: US 2014/0050052 A1
(43) Pub. Date: Feb. 20, 2014

(54) METHOD AND SYSTEM FOR DETECTING SPATIAL POSITION OF INDICATOR OBJECT BY USING SOUND WAVE

(71) Applicant: AU OPTRONICS CORP., Hsin-Chu (TW)

(72) Inventors: JWU-SHENG HU, Hsin-Chu (TW); CHUNG-WEI JUAN, Hsin-Chu (TW); FANG-CHING LEE, Hsin-Chu (TW)

(73) Assignee: AU OPTRONICS CORP., Hsin-Chu (TW)

(21) Appl. No.: 13/827,554

(22) Filed: Mar. 14, 2013

(30) Foreign Application Priority Data
Aug. 17, 2012 (TW) 101130001

(51) Int. Cl. G01S 15/08

(52) U.S. Cl. CPC G01S 15/08
USPC 367/99

(57) ABSTRACT

A method for detecting a spatial position of an indicator object by using sound waves. The method is adapted to be used with a sound wave transceiver device and a plurality of sound wave receiving devices. The method includes steps of: obtaining a relative position of the sound wave transceiver device to each one of the sound wave receiving devices; obtaining a plurality of reflection times respectively indicating time periods from the sound wave transceiver device emitting the sound wave to the sound wave transceiver device and the sound wave receiving devices receiving the reflected sound wave from the indicator object; and calculating a position of the indicator object according to the relative positions and the reflection times. A system for detecting a spatial position of an indicator object by using sound waves is also provided.

### TECHNICAL FIELD

The present disclosure relates to method and system for detecting a spatial position of an indicator object, and more particularly to method and system for detecting a spatial position of an indicator object by using sound waves.

### BACKGROUND

The conventional capacitive, resistive and surface sound-wave wave touch technologies can only detect a touch event on a touch screen surface, and are not suitable for a large-scaled touch application due to the yield limitation, which consequently results in a cost rising. The touch control can be also realized by a depth camera; however, the depth camera can only detect a touch event 30 cm away from a display screen due to the optical technology limitation and accordingly is not suitable for detecting a touch event closing to a touch screen. In addition, due to having camera angle limitation issue, the depth camera is also not suitable for a large-scaled touch application.

Thus, a so-called pulse-echo ultrasound technology is developed to be used for detecting a touch event closing to a surface of a large-scaled touch screen. In the pulse-echo ultrasound technology, a distance between a to-be-detected object and a sensor is determined by using the sound velocity and the geometric relationships. However, the pulse-echo ultrasound technology still has two issues. One is that the value of the sound velocity needs to be updated always in response to a varying of sound velocity resulted from temperature and humidity changes. The other is that the computing load is relatively high by using the reflection time information to calculate the three-dimensional coordinates of the object and consequently results in a complex computing process.

### SUMMARY

The present disclosure provides method and system for detecting a spatial position of an indicator object by using sound waves; thus, a position of an object can be measured without the determination of sound velocity.

An embodiment of the disclosure provides a system for detecting a spatial position of an indicator object by using sound waves. The system includes a sound wave transceiver device, a first sound wave receiving device, a second sound wave receiving device, a recording device and a computing unit. The sound wave transceiver device is configured to emit a sound wave to the indicator object and receive a first sound wave reflection signal resulted from the sound wave reflected by the indicator object. The first sound wave receiving device is configured to receive a second sound wave reflection signal resulted from the sound wave reflected by the indicator object. The second sound wave receiving device is configured to receive a third sound wave reflection signal resulted from the sound wave reflected by the indicator object. The recording device is configured to record a first relative position information, which indicates a relative position between the first sound wave receiving device and the sound wave transceiver device, and a second relative position information, which indicates a relative position between the second sound wave receiving device and the sound wave transceiver device. The computing unit is configured to calculate a position of the indicator object according to a first reflection time indicating a time period from the sound wave transceiver device emitting the sound wave to the sound wave transceiver device receiving the first sound wave reflection signal, a second reflection time indicating a time period from the sound wave transceiver device emitting the sound wave to the first sound wave receiving device receiving the second sound wave reflection signal, a third reflection time indicating a time period from the sound wave transceiver device emitting the sound wave to the second sound wave receiving device receiving the third sound wave reflection signal, the first relative position information and the second relative position information.

Another embodiment of the disclosure provides a method for detecting a spatial position of an indicator object by using sound waves. The method is adapted to be used with a sound wave transceiver device and a plurality of sound wave receiving devices. The method includes steps of: obtaining a relative position of the sound wave transceiver device to each one of the sound wave receiving devices; obtaining a plurality of reflection times respectively indicating time periods from the sound wave transceiver device emitting the sound wave to the sound wave transceiver device and the sound wave receiving devices receiving the reflected sound wave from the indicator object; and calculating a position of the indicator object according to the relative positions and the reflection times.

In summary, by recording the relative positions of a sound wave transceiver device and a plurality of sound wave receiving devices and using reflection times and corresponding geometric relationships of the sound wave transceiver device and the sound wave receiving devices, the present disclosure can calculate the spatial position of an indicator object without knowing the sound velocity.

### BRIEF DESCRIPTION OF THE DRAWINGS

The present disclosure will become more readily apparent to those ordinarily skilled in the art after reviewing the following detailed description and accompanying drawings, in which:

FIG. 1 is a schematic view illustrating a system for detecting a spatial position of an indicator object by using sound waves in accordance with an embodiment of the present disclosure;

FIG. 2 is a schematic top view of the system 10 shown in FIG. 1; and

FIG. 3 is a flowchart illustrating a method for detecting a spatial position of an indicator object by using sound waves in accordance with an embodiment of the present disclosure.

### DETAILED DESCRIPTION OF PREFERRED EMBODIMENTS

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

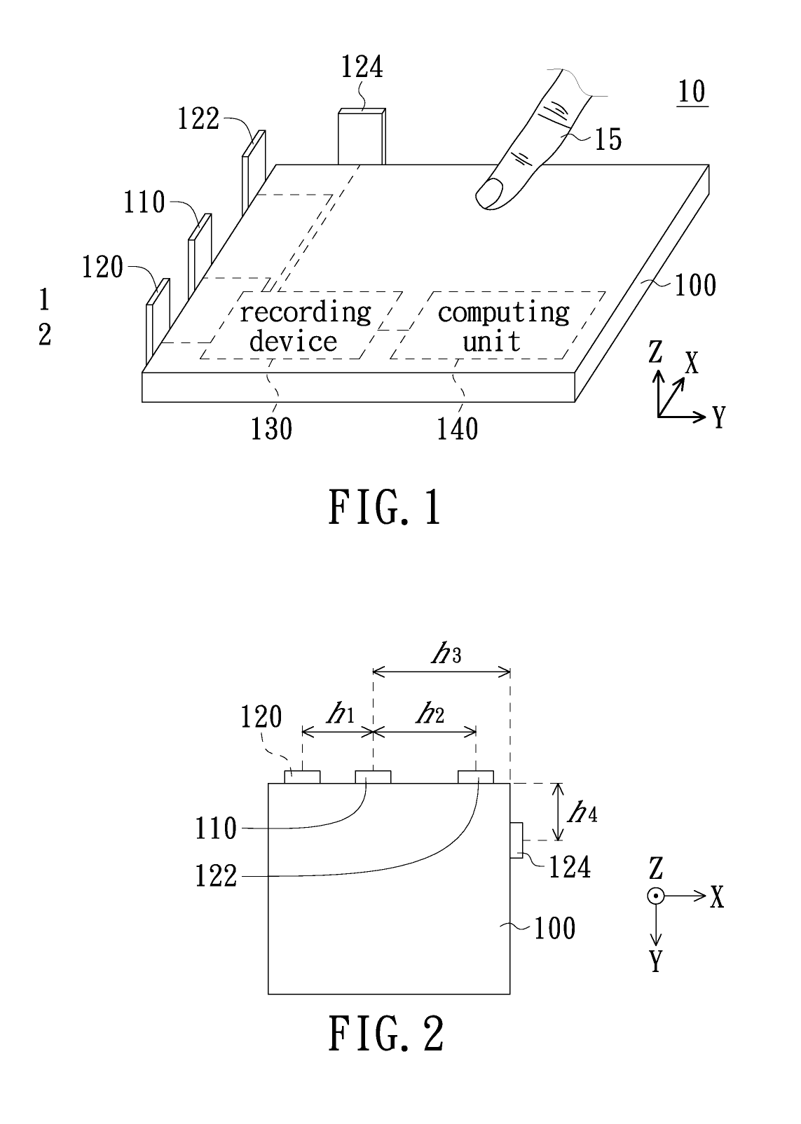

FIG. 1 is a schematic view illustrating a system for detecting a spatial position of an indicator object by using sound waves in accordance with an embodiment of the present disclosure. As shown, the system 10 in this embodiment includes a sound wave transceiver device 110, three sound wave receiving devices 120, 122 and 124, a recording device 130 and a computing unit 140. Although these devices and units are exemplified by being arranged around or inside of a panel 100, it is to be noted that the design of the present embodiment is not limited thereto. For example, the panel 100 can be a screen for displaying images only and without the touch function, or a board for writing and drawing thereon. In addition, it is understood that the recording device 130 and the computing unit 140 can be arranged independently and coupled to the sound wave transceiver device 110 and the sound wave receiving devices 120, 122 and 124 by way of data communication, instead of being arranged inside the panel 100 (a screen or a board).

In this embodiment as shown in FIG. 1, the sound wave transceiver device 110 is configured to emit a sound wave for a follow-up measuring operation. Specifically, the sound wave emitted from the sound wave transceiver device 110 is reflected after being emitted on an indicator object 15, and accordingly a portion of the reflected sound wave is received by the sound wave transceiver device 110 and the sound wave receiving devices 120, 122 and 124. The time differences, between the time point of the sound wave transceiver device 110 emitting the sound wave and the time point of the sound wave receiving devices 120, 122 and 124 receiving the respective reflected sound wave (hereafter is called a sound wave reflection signal), are transmitted to the recording device 130 or directly transmitted to the computing unit 140. The computing unit 140 is configured to calculate a spatial position of the indicator object 15 based on the time differences and the relative position information among the sound wave transceiver device 110 and the sound wave receiving devices 120, 122 and 124 recorded in the recording device 130.

FIG. 2 is a schematic top view of the system 10 shown in FIG. 1. It is to be noted that the relative positions among the sound wave transceiver device 110 and the sound wave receiving devices 120, 122 and 124 herein are used for an exemplification only, and the actual lengths and widths of the sound wave transceiver device 110 and the sound wave receiving devices 120, 122 and 124 are not limited thereto.

As shown in FIG. 2, the sound wave transceiver device 110 is referred as an original point of a coordinate in this embodiment. The sound wave receiving device 120 has, relative to the sound wave transceiver device 110, a displacement h1 on the X-axis and no displacement on the Y-axis and Z-axis; the sound wave receiving device 122 has, relative to the sound wave transceiver device 110, a displacement h2 on the X-axis and no displacement on the Y-axis and Z-axis; the sound wave receiving device 124 has, relative to the sound wave transceiver device 110, a displacement h3 on the X-axis, a displacement h4 on the Y-axis and no displacement on the Z-axis. The aforementioned displacements among the sound wave transceiver device 110 and the sound wave receiving devices 120, 122 and 124 are recorded in the recording device 130 for a follow-up calculation.

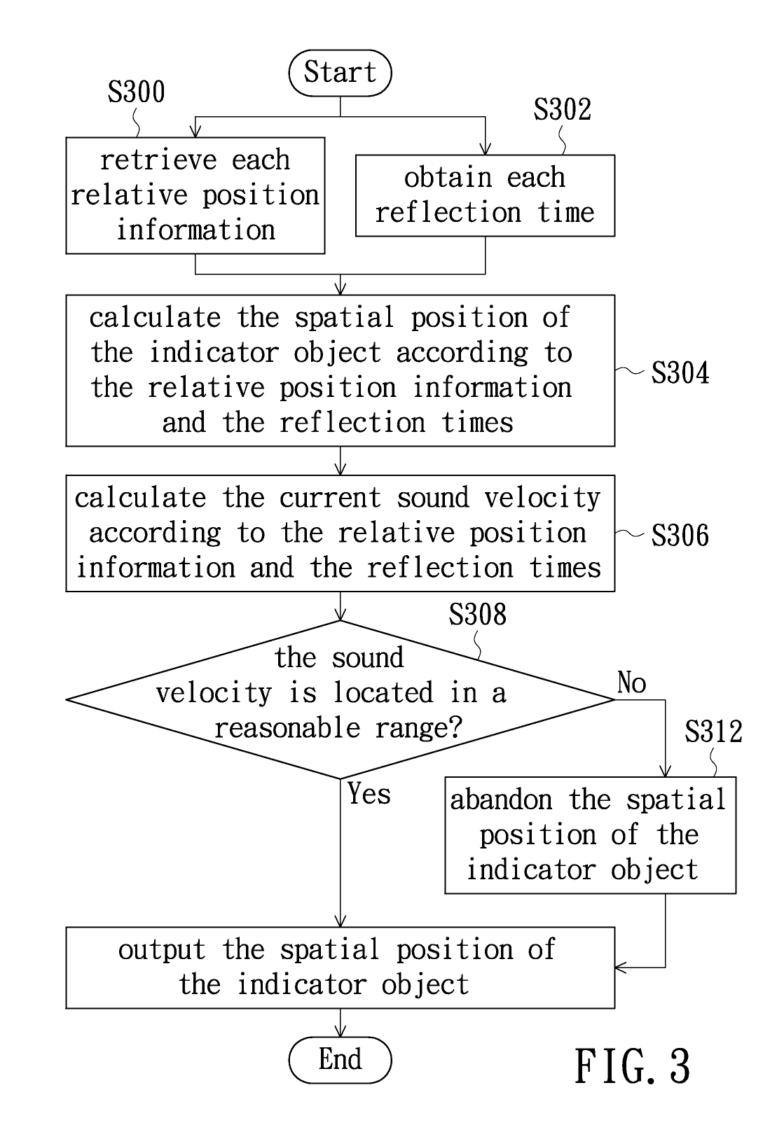

FIG. 3 is a flowchart illustrating a method for detecting a spatial position of an indicator object by using sound waves in accordance with an embodiment of the present disclosure. For the convenience of description, please refer to FIGS. 1 and 3 both. In this embodiment, the method first retrieves each relative position information from the recording device 130 (step S300). After the sound wave transceiver device 110 and the sound wave receiving devices 120, 122 and 124 each receiving the respective sound wave reflection signal, the method calculates the time differences, between the time point of the sound wave transceiver device 110 emitting the sound wave and the time point of the sound wave receiving devices 120, 122 and 124 each receiving the respective sound wave reflection signal, and refers the time differences as reflection times (step S302). The method then provides the each relative position information and the reflection times to the computing unit 140 to calculate the spatial position of the indicator object 15 (step S304).

The following is an exemplary way to calculate the spatial position of an indicator position.

Xⱼ=[xᵢ yᵢ zᵢ]^{T} represents the spatial coordinate of the sound wave transceiver device 110 and the sound wave receiving devices 120, 122 and 124. Specifically, X₁ represents the spatial coordinate of the sound wave transceiver device 110; X₂ represents the spatial coordinate of the sound wave receiving device 120; X₃ represents the spatial coordinate of the sound wave receiving device 122; and X₄ represents the spatial coordinate of the sound wave receiving device 124. In addition, the reflection time of the sound wave transceiver device 110 to one of the sound wave receiving devices 120, 122 and 124 can be represented as τᵢ. Specifically, the reflection time from the sound wave transceiver device 110 emitting a sound wave to the sound wave transceiver device 110 receiving the reflected sound wave is represented as τ₁; the reflection time from the sound wave transceiver device 110 emitting a sound wave to the sound wave receiving device 120 receiving the reflected sound wave is represented as τ₂; the reflection time from the sound wave transceiver device 110 emitting a sound wave to the sound wave receiving device 122 receiving the reflected sound wave is represented as τ₃, and the reflection time from the sound wave transceiver device 110 emitting a sound wave to the sound wave receiving device 124 receiving the reflected sound wave is represented as τ₄.

Thus, according to the geometric spatial relationships among the sound wave transceiver device 110, the sound wave receiving devices 120, 122 and 124 and the indicator object 150, there exits an equation:

(Xᵢ−X₁)^{T}X+(vτ₁−vτᵢ)*vτ₁/2=(½)*(|Xᵢ|²−|X₁|²+v²τ₁²−v²τᵢ²)

wherein v represents the unknown sound velocity, X=[x y z]^{T} represents the spatial position of the indicator object 15.

The following three equations are obtained by configuring i to 2, 3 and 4 in the above equation:

$${( {X}_{3} - {X}_{1} )}^{T} X + ( v {τ}_{1} - v {τ}_{3} ) \frac{v {τ}_{1}}{2} = \frac{1}{2} ( {\vert {X}_{3} \vert}^{2} - {\vert {X}_{1} \vert}^{2} + {v}^{2} {τ}_{1}^{2} - {v}^{2} {τ}_{3}^{2} )$$

$${( {X}_{2} - {X}_{1} )}^{T} X + ( v {τ}_{1} - v {τ}_{2} ) \frac{v {τ}_{1}}{2} = \frac{1}{2} ( {\vert {X}_{2} \vert}^{2} - {\vert {X}_{1} \vert}^{2} + {v}^{2} {τ}_{1}^{2} - {v}^{2} {τ}_{2}^{2} )$$

$${( {X}_{4} - {X}_{1} )}^{T} X + ( v {τ}_{1} - v {τ}_{4} ) \frac{v {τ}_{1}}{2} - \frac{1}{2} ( {\vert {X}_{4} \vert}^{2} - {\vert {X}_{1} \vert}^{2} + {v}^{2} {τ}_{1}^{2} - {v}^{2} {τ}_{4}^{2} )$$

The above equations can be simplified to:

$$\begin{matrix}{( {X}_{2} - X - 1 )}^{T} \frac{x}{{v}^{2}} - \frac{1}{2} ( {\vert {X}_{2} \vert}^{2} - {\vert {X}_{1} \vert}^{2} ) \frac{1}{{v}^{2}} = \frac{1}{2} ( {τ}_{1}^{2} - {τ}_{2}^{2} ) - \frac{1}{2} ( {τ}_{1} - {τ}_{2} ) {τ}_{1} & ( 1 ) \\ {( {X}_{3} - {X}_{1} )}^{T} \frac{x}{{v}^{2}} - \frac{1}{2} ( {\vert {X}_{3} \vert}^{2} - {\vert {X}_{1} \vert}^{2} ) \frac{1}{{v}^{2}} = \frac{1}{2} ( {τ}_{1}^{2} - {τ}_{3}^{2} ) - \frac{1}{2} ( {τ}_{1} - {τ}_{3} ) {τ}_{1} & ( 2 ) \\ {( {X}_{4} - {X}_{1} )}^{T} \frac{x}{{v}^{2}} - \frac{1}{2} ( {\vert {X}_{4} \vert}^{2} - {\vert {X}_{1} \vert}^{2} ) \frac{1}{{v}^{2}} = \frac{1}{2} ( {τ}_{1}^{2} - {τ}_{4}^{2} ) - \frac{1}{2} ( {τ}_{1} - {τ}_{4} ) {τ}_{1} & ( 3 )\end{matrix}$$

As shown, there exist four unknowns in the above equations (1), (2) and (3), wherein three unknowns x, y and z corporately represent the spatial position of the indicator object 15 and one unknown v represents the sound velocity.

The equations (1), (2) and (3) can be simplified to:

$$[ \begin{matrix}{( {X}_{2} - {X}_{1} )}^{T} - \frac{1}{2} ( {\vert {X}_{2} \vert}^{2} - {\vert {X}_{1} \vert}^{2} ) \\ {( {X}_{3} - {X}_{1} )}^{T} - \frac{1}{2} ( {\vert {X}_{3} \vert}^{2} - {\vert {X}_{1} \vert}^{2} ) \\ {( {X}_{4} - {X}_{1} )}^{T} - \frac{1}{2} ( {\vert {X}_{4} \vert}^{2} - {\vert {X}_{1} \vert}^{2} )\end{matrix} ] [ \begin{matrix}{w}_{1} \\ {w}_{2} \\ {w}_{3} \\ {w}_{4}\end{matrix} ] = [ \begin{matrix}\frac{1}{2} ( {τ}_{1}^{2} - {τ}_{2}^{2} ) - \frac{1}{2} ( {τ}_{1} - {τ}_{2} ) {τ}_{1} \\ \frac{1}{2} ( {τ}_{1}^{2} - {τ}_{3}^{2} ) - \frac{1}{2} ( {τ}_{1} - {τ}_{3} ) {τ}_{1 } \\ \frac{1}{2} ( {τ}_{1}^{2} - {τ}_{4}^{2} ) - \frac{1}{2} ( {τ}_{1} - {τ}_{4} ) {τ}_{1}\end{matrix} ] \qquad ( 4 )$$

wherein

$${W}^{*} = \frac{x}{{v}^{2}}$$

and W* is expressed as

$${\frac{1}{{v}^{2}} [ x y z ]}^{T} ; \frac{x}{{v}^{2}} = {w}_{1} ,$$

and W* is expressed as [w₁ w₂ w₃]^{T};

$${w}_{4} = \frac{1}{{v}^{2}} .$$

The equation (4) has no unique solution due to there existing four unknowns. However, the impact of unknown w₃ will be eliminated by arranging the sound wave transceiver device 110 and the sound wave receiving devices 120, 122 and 124 on the same plane. In other words, by making X₁=[0 0], X₂=[−h₁ 0], X₃=[h₂ 0] and X₄=[h₃ h₄], the equation (4) has less dimension and can be rewritten as:

$$[ \begin{matrix}- {h}_{1} & 0 & - \frac{1}{2} {h}_{1}^{2} \\ {h}_{2} & 0 & - \frac{1}{2} {h}_{2}^{2} \\ {h}_{3} & {h}_{4} & - \frac{1}{2} ( {h}_{3}^{2} + {h}_{4}^{2} )\end{matrix} ] [ \begin{matrix}{w}_{1} \\ {w}_{2} \\ {w}_{4}\end{matrix} ] = [ \begin{matrix}\frac{1}{2} ( {τ}_{1}^{2} - {τ}_{2}^{2} ) - \frac{1}{2} ( {τ}_{1} - {τ}_{2} ) {τ}_{1} \\ \frac{1}{2} ( {τ}_{1}^{2} - {τ}_{3}^{2} ) - \frac{1}{2} ( {τ}_{1} - {τ}_{3} ) {τ}_{1} \\ \frac{1}{2} ( {τ}_{1}^{2} - {τ}_{4}^{2} ) - \frac{1}{2} ( {τ}_{1} - {τ}_{4} ) {τ}_{1}\end{matrix} ] \qquad ( 5 )$$

If the first matrix in equation (5) is represented as F, the second matrix in equation (5) is represented as W, the third matrix in equation (5) is represented as B, the equation (5) can be rewritten as FW=B, and the solution of the equation FW=B can be expressed as W=F⁻¹B

Because the values h1, h2, h3 and h4 respectively indicating the displacements between the sound wave transceiver device 110 and the sound wave receiving devices 120, 122 and 124 are already known, all elements in matrix F are known and accordingly the value of matrix F⁻¹ can be obtained in advance without the matrix inverse operation on matrix W. Thus, the system 10 in this embodiment has lower computation.

Once the solution of the array W is obtained, the X-axis coordinate x and the Y-axis coordinate y of the indicator object 15 and the current sound velocity can be obtained by the following equations:

x=w₁/w₄

y=w₂/w₄

v=\sqrt{1/w₄}

In addition, because the sound wave transceiver device 110 is configured to transmit/receive sound waves both and the distance between the indicator object 15 and the sound wave transceiver device 110 is τ1/2w4, the Z-axis coordinate z of the indicator object 15 can be obtained by the following equation:

$$z = \sqrt{{( \frac{{τ}_{1}}{2 {w}_{4}} )}^{2} - {( \frac{{w}_{1}}{{w}_{4}} )}^{2} - {( \frac{{w}_{2}}{{w}_{4}} )}^{2}}$$

Thus, the spatial position of the indicator object 15 is determined, and accordingly the system 10 for detecting a spatial position of an indicator object by using sound waves can perform the follow-up operation according to the calculated spatial position of the indicator object 15.

In another embodiment, the process of determining the spatial position of the indicator object 15 is completed when the position of the indicator object 15 is obtained in step S304. However, as illustrated in FIG. 3, the method in this embodiment further calculates the current sound velocity according to w₄, which is exported according to the parameters obtained in steps S300 and S302 after the obtainment of the spatial position of the indicator object 15 (step S306). The method, after obtaining the sound velocity, determines the calculated sound velocity whether or not being located in a reasonable range (step S308). The currently-calculated spatial position of the indicator object 15 is determined as being reasonable if the corresponding calculated sound velocity is located in a reasonable range, and consequentially the method in this embodiment outputs this calculated spatial position of the indicator object 15 for the follow-up operations (step S310). Alternatively, the method in this embodiment abandon this currently-calculated spatial position of the indicator object 15 if the corresponding calculated sound velocity is not located in a reasonable range (step S312).

In other words, the sound velocity is used to determine whether the calculated spatial position of the indicator object 15 is reasonable or not rather than directly used to calculate the spatial position of the indicator object 15. Therefore, the sound velocity is not a necessary parameter for the calculation of the spatial position of the indicator object 15, and accordingly there is no need to update the sound velocity in real time during the spatial position calculation period of the indicator object 15. Thus, the requirement of the real-time update of sound velocity in prior art is avoided and consequentially the corresponding computational steps can be omitted.

According to the embodiments of the present disclosure, the three-dimensional position of the indicator object 15 can be determined by arranging the sound wave transceiver device 110 and the sound wave receiving devices 120, 122 and 124 on the same plane; however, it is to be noted that the equation (5) cannot have a correct solution if the sound wave transceiver device 110 and the sound wave receiving devices 120, 122 and 124 specifically have a straight-line alignment. From another point of view, an additional sound wave receiving device is needed, compared with the system 10 shown in FIG. 1, for calculating the three-dimensional position of the indicator object 15 based on the aforementioned calculation process if the sound wave receiving devices 120, 122 and 124 are not arranged on the same plane.

Furthermore, it is understood that the calculation of a two-dimensional position of the indicator object 15 can be realized by arranging one sound wave transceiver device and two sound wave receiving devices having a straight-line alignment. And the calculation of the two-dimensional position of the indicator object 15 can be based on the same manner of that in the calculation of the three-dimensional position described previously; and no unnecessary detail is given here.

Furthermore, it is to be noted that the sound wave used in the present disclosure is referred to as a regular sound wave (having a frequency located between 10˜20 KHz) as well as an ultrasound wave (having a frequency located between 20K˜200 KHz).

In summary, by recording the relative positions of a sound wave transceiver device and a plurality of sound wave receiving devices and using reflection times and corresponding geometric relationships of the sound wave transceiver device and the sound wave receiving devices, the present disclosure can calculate the spatial position of an indicator object without knowing the sound velocity.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A system for detecting a spatial position of an indicator object by using sound waves, comprising:
a sound wave transceiver device configured to emit a sound wave to the indicator object and receive a first sound wave reflection signal resulted from the sound wave reflected by the indicator object;
a first sound wave receiving device configured to receive a second sound wave reflection signal resulted from the sound wave reflected by the indicator object;
a second sound wave receiving device configured to receive a third sound wave reflection signal resulted from the sound wave reflected by the indicator object;
a recording device configured to record a first relative position information, which indicates a relative position between the first sound wave receiving device and the sound wave transceiver device, and a second relative position information, which indicates a relative position between the second sound wave receiving device and the sound wave transceiver device; and
a computing unit configured to calculate a position of the indicator object according to a first reflection time indicating a time period from the sound wave transceiver device emitting the sound wave to the sound wave transceiver device receiving the first sound wave reflection signal, a second reflection time indicating a time period from the sound wave transceiver device emitting the sound wave to the first sound wave receiving device receiving the second sound wave reflection signal, a third reflection time indicating a time period from the sound wave transceiver device emitting the sound wave to the second sound wave receiving device receiving the third sound wave reflection signal, the first relative position information and the second relative position information.

2. The system according to claim 1, wherein the sound wave transceiver device, the first sound wave receiving device and the second sound wave receiving device are aligned along a straight line.

3. The system according to claim 1, further comprising:
a third sound wave receiving device configured to receive a fourth sound wave reflection signal resulted from the sound wave reflected by the indicator object,
wherein the recording device is further configured to record a third relative position information indicating a relative position between the third sound wave receiving device and the sound wave transceiver device, the computing unit is further configured to calculate the position of the indicator object according to the third relative position information and a fourth reflection time indicating a time period from the sound wave transceiver device emitting the sound wave to the third sound wave receiving device receiving the fourth sound wave reflection signal.

4. The system according to claim 3, wherein the sound wave transceiver device, the first sound wave receiving device, the second sound wave receiving device and the third sound wave receiving device are arranged on a same plane but not aligned along a same straight line.

5. A method for detecting a spatial position of an indicator object by using sound waves, the method being adapted to be used with a sound wave transceiver device and a plurality of sound wave receiving devices, the method comprising:
obtaining a relative position of the sound wave transceiver device to each one of the sound wave receiving devices;
obtaining a plurality of reflection times respectively indicating time periods from the sound wave transceiver device emitting the sound wave to the sound wave transceiver device and the sound wave receiving devices receiving the reflected sound wave from the indicator object; and
calculating a position of the indicator object according to the relative positions and the reflection times.

6. The method according to claim 5, wherein the sound wave receiving devices are arranged on a same plane but not aligned along a same straight line.

7. The method according to claim 6, wherein the position of the indicator object is calculated based on an equation of:
(Xᵢ−X₁)^{T}X+(vτ₁−vτᵢ)*vτ₁/2=(½)*(|Xᵢ|²−|X₁|²+v²τ₁²−v²τᵢ²),
wherein Xᵢ=[xᵢ yᵢ zᵢ]^{T} and i=1 represent the spatial position of the sound wave transceiver device, Xᵢ=[xᵢ yᵢ zᵢ]^{T} and i=1, . . . , n respectively represent the spatial positions of the sound wave receiving devices;
τᵢ represents the reflection time, specifically, τᵢ and i=1 represent the reflection time from the sound wave transceiver to the sound wave transceiver itself, τᵢ and i=1, . . . , n respectively represent the reflection times from the sound wave transceiver to the sound wave receiving devices,
v represents a sound velocity.

8. The method according to claim 5, further comprising:
calculating a corresponding sound velocity.

9. The method according to claim 8, further comprising:
determining whether the calculated position of the indicator object is reasonable or not according to the corresponding sound velocity.
